(19) United States
(12) Patent Application Publication
(10) Pub. No.: US 2010/0135488 A1
(43) Pub. Date: Jun. 3, 2010

(54) SVC ENCRYPTION APPARATUS AND METHOD AND CONTENTS PROVIDING SYSTEM AND METHOD

(75) Inventors: Seungmin LEE, Daejeon (KR); Yong Hyuk MOON, Daejeon (KR); Ja-Beom GU, Daejeon (KR); Hyeok Chan KWON, Daejeon (KR); Yong-Sung JEON, Daejeon (KR); Taek Yong NAM, Daejeon (KR); Jae Hoon NAH, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/489,718

(22) Filed: Jun. 23, 2009

(30) Foreign Application Priority Data
Dec. 1, 2008 (KR) 10-2008-0120808
Mar. 31, 2009 (KR) 10-2009-0027584

(51) Int. Cl. H04N 7/167; H04K 1/00

(52) U.S. Cl. 380/200; 380/255

(57) ABSTRACT

An SVC encryption apparatus includes: an encoding/encryption unit for performing SVC (Scalable Video Coding) encoding on input data contents and carrying out encryption for data in accordance with a first encryption condition to generate a corresponding SVC bitstream; and a NAL (Network Adaptation Layer) data analysis unit for analyzing NAL data of the generated SVC bitstream to find out NAL data satisfying a second encryption condition. Further, the SVC encryption apparatus includes a conditional NAL data encryption unit for encrypting the extracted NAL data in accordance with the second encryption condition; and a bitstream transmitting unit for transmitting the SVC bitstream with encrypted NAL data.

### CROSS-REFERENCE TO RELATED APPLICATIONS

The present invention claims priority of Korean Patent Application No. 10-2008-0120808, filed on Dec. 1, 2008, and Korean Patent Application No. 10-2009-0027584, filed on Mar. 31, 2009, which is incorporated herein by references.

### FIELD OF THE INVENTION

The present invention relates to a contents providing technique using SVC (Scalable Video Coding) encryption, and more particularly, to an SVC encryption apparatus and method and a contents providing system and method suitable for carrying out SVC encryption of contents in response to a request to transmit contents and providing encrypted contents to a client terminal apparatus.

### BACKGROUND OF THE INVENTION

As well known in the art, in the field of IPTV service, SVC is one of scalable video coding techniques based on a concept of OSMU (one-source and multi-use) that content is transmitted and serviced to different terminals at the same time.

When the IPTV service is provided by using the SVC, in terms of security, there is a requirement to be taken into consideration. That is, a terminal that receives SVC-encrypted contents decodes the SVC-encrypted contents with an encryption key conforming to the terminal, while media conversion is carried out without decryption and decoding the encrypted SVC content at an intermediate node on the network, thereby ensuring end-to-end security.

In order to meet the requirement, in the related art, an encryption technique using NAL (Network Adaptation Layer) data is suggested. This encryption technique provides conditional access control for “(dependency_id, temporal_id, quality_id)”, which provides spatial, temporal, and quality scalabilities in the NAL data structure. In this case, NAL data as an encryption target is encrypted by prescribed scalabilities, and a user access is limited in accordance with a key combination for an access to a specific scalability, thereby protecting contents.

When the IPTV service is provided by using the SVC, it is required to be taken into consideration that, SVC-encrypted contents is reproduced on a terminal, an encryption mechanism is capable of decentralize a load due to encryption in consideration of the conditions of the terminal (performance and power of a mobile phone, a PC, a TV or the like). For example, even if secure media conversion is ensured at the intermediate node, a small terminal, such as a mobile phone, has a limit in performance for decoding. Therefore, if the limit is not taken into consideration, a severe problem may occur at the time of commercialization.

The related art relates to key management for secure media conversion at the intermediate node and conditional access control of the user, but it has a problem in that encryption load decentralization suitable for the terminal environment is difficult.

### SUMMARY OF THE INVENTION

In view of the above, the present invention provides an SVC encryption apparatus and method and a contents providing system and method capable of achieving secure media conversion at an intermediate node and encryption load decentralization in consideration of conditions of a user terminal at the time of transmission of contents using SVC.

Further, the present invention provides an SVC encryption apparatus and method and a contents providing system and method capable of carrying out encryption at two portions during and after encoding, thereby adjusting computational complexity.

In accordance with a first aspect of the present invention, there is an SVC encryption apparatus including: an encoding/encryption unit for performing SVC (Scalable Video Coding) encoding on input contents and carrying out encryption for the encoded data in accordance with a first encryption condition, i.e., the encryption is included in the encoding, to generate a corresponding SVC bitstream; a NAL (Network Adaptation Layer) data analysis unit for analyzing NAL data of the generated SVC bitstream to find out NAL data satisfying a second encryption condition, i.e., the encryption is independently carried out with the encoding; a conditional NAL data encryption unit for encrypting the extracted NAL data in accordance with the second encryption condition; and a bitstream transmitting unit for transmitting the SVC bitstream with encrypted NAL data.

In accordance with a second aspect of the present invention, there is an SVC encryption method including: SVC (Scalable Video Coding) encoding input contents and carrying out encryption for data in accordance with a first encryption condition to generate a corresponding SVC bitstream; analyzing NAL data of the generated SVC bitstream to find out NAL data satisfying a second encryption condition; encrypting extracted NAL data in accordance with the second encryption condition; and transmitting the SVC bitstream with encrypted NAL data.

In accordance with a third aspect of the present invention, there is an contents providing system including: a contents service apparatus for carrying out SVC (Scalable Video Coding) encryption for requested contents to generate an SVC bitstream, encrypting NAL data extracted from the generated SVC bitstream to transmit the SVC bitstream with encrypted NAL data; a media conversion apparatus for carrying out media conversion for the transmitted SVC bitstream in accordance with a terminal condition; and a client terminal apparatus for decoding the media-converted SVC bitstream to reproduce corresponding contents.

In accordance with a fourth aspect of the present invention, there is a contents providing method including: SVC (Scalable Video Coding) encrypting for requested contents to generate an SVC bitstream; encrypting NAL data extracted from the generated SVC bitstream; transmitting the SVC bitstream with encrypted NAL data; carrying out media conversion for the transmitted SVC bitstream in accordance with a terminal condition to transmit the media-converted SVC bitstream to a client terminal apparatus.

The present invention is characterized in that SVC encryption is carried out for requested contents to generate an SVC bitstream, NAL data extracted from the generated SVC bitstream is encrypted, the SVC bitstream with encrypted NAL data is transmitted, media conversion is carried out for the transmitted SVC bitstream depending on a terminal condition, and the media-converted SVC bitstream is provided to a client terminal apparatus. With this technical means, the drawbacks inherent in the related art can be resolved.

In accordance with the present invention, when requested contents is encoded by the SVC scheme, a specific portion is encrypted to generate an SVC bitstream, and conditional data encryption is further carried out for NAL data of the generated bitstream. Therefore, secure media conversion can be carried out at a network node, and encryption load decentralization based on the terminal condition of a client terminal apparatus, which requests contents, can be achieved.

### BRIEF DESCRIPTION OF THE DRAWINGS

The objects and features of the present invention will become apparent from the following description of an embodiment given in conjunction with the accompanying drawings, in which:

FIG. 1 is a block diagram of a contents providing system suitable for providing SVC-encrypted contents to a client terminal apparatus in accordance with an embodiment of the present invention;

FIG. 2 is a block diagram of a contents service apparatus suitable for carrying out SVC encryption for contents and transmitting SVC-encrypted contents shown in FIG. 1;

FIG. 3 is a block diagram of an SVC encryption apparatus suitable for SVC encryption of contents shown in FIG. 2;

FIG. 4 is a diagram showing an encoding/encryption unit generating an SVC bitstream based on SVC encryption during contents encoding in accordance with the embodiment of the invention;

FIG. 5 is a diagram showing an SVC NAL head structure used in a conditional NAL data encryption unit in accordance with the embodiment of the invention;

FIG. 6 is a diagram illustrating encryption of conditional NAL data in accordance with the embodiment of the invention;

FIG. 7 is a flowchart showing a process for providing SVC-encrypted contents to a client terminal apparatus in accordance with the embodiment of the invention; and

FIG. 8 is a diagram illustrating a process for converting video contents depending on a terminal condition and providing converted video contents in accordance with the embodiment of the invention when encrypted video contents is transmitted.

### DETAILED DESCRIPTION OF THE EMBODIMENT

Hereinafter, an embodiment of the invention will be described with reference to the drawings which form a part hereof.

FIG. 1 is a block diagram of a contents providing system suitable for providing SVC-encrypted contents to a client terminal apparatus in accordance with an embodiment of the invention. The contents providing system includes a contents service apparatus 100, a media conversion apparatus 200 and a client terminal apparatus 300.

Referring to FIG. 1, the contents service apparatus 100 provides contents of IPTV. Specifically, the contents service apparatus 100 carries out SVC encryption for contents, i.e., video contents requested by the client terminal apparatus 300, to generate an SVC bitstream, encrypts NAL data extracted from the generated SVC bitstream, and transmits the SVC bitstream with encrypted NAL data to the media conversion apparatus 200, for example, in a streaming manner or the like.

The media conversion apparatus 200 includes a transcoder or the like. The media conversion apparatus 200 carries out media conversion for the SVC bitstream transmitted from the contents service apparatus 100 depending on the terminal condition for example, CPU performance, video codec performance and the like of the client terminal apparatus 300, and transmits the media-converted SVC bitstream to the client terminal apparatus 300. With respect to the SVC bitstream subjected to first encryption, second encryption, and third encryption, the media conversion apparatus 200 may carry out media conversion such that, depending on the terminal condition, the SVC bitstream is reproduced through decoding of a portion subjected to the first encryption, portions subjected to the first encryption and the second encryption, or all portions subjected to the first encryption, the second encryption and the third encryption.

The client terminal apparatus 300 is exemplified by a digital TV, a PC, a mobile communication terminal or the like. The client terminal apparatus 300 decodes the media-converted SVC bitstream transmitted from the media conversion apparatus 200 in accordance with the request for contents, and reproduces the contents.

Next, in the contents providing system having the above-described configuration, the contents service apparatus 100 that caries out SVC encryption for contents to generate an SVC bitstream, encrypts NAL data extracted from the generated SVC bitstream, and transmits the SVC bitstream with encrypted NAL data in a streaming manner will be described.

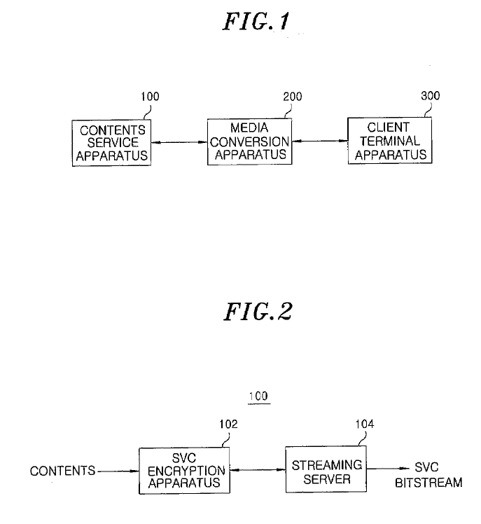

FIG. 2 is a block diagram of a contents service apparatus suitable for carrying out SVC encryption for contents and transmitting SVC-encrypted contents, according to an embodiment of the invention. The contents service apparatus 100 includes an SVC encryption apparatus 102 and a streaming server 104.

Referring to FIG. 2, if contents, i.e., video contents requested by the client terminal apparatus 300 is inputted, the SVC encryption apparatus 102 carries out encoding and SVC encryption for the inputted contents to generate an SVC bitstream, extracts and encrypts NAL data from the generated SVC bitstream, and transmits the SVC bitstream with encrypted NAL data to the streaming server 104.

The streaming server 104 transmits the SVC bitstream with encrypted NAL data transmitted from the SVC encryption apparatus 102, to the media conversion apparatus 200, for example, in a streaming manner or the like.

Next, in the contents service apparatus 100 having the above-described configuration, the SVC encryption apparatus 102 that carries out SVC encryption for contents to generate an SVC bitstream, encrypts NAL data extracted from the generated SVC bitstream, and transmits the SVC bitstream with encrypted NAL data will be described.

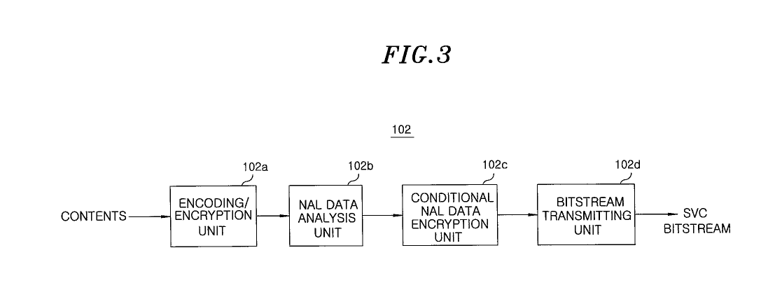

FIG. 3 is a block diagram of an SVC encryption apparatus suitable for SVC encryption of contents shown in FIG. 2. The SVC encryption apparatus 102 includes an encoding/encryption unit 102a, a NAL data analysis unit 102b, a conditional NAL data encryption unit 102c and a bitstream transmitting unit 102d.

Referring to FIG. 3, the encoding/encryption unit 102a encrypts data in accordance with a first encryption condition during SVC encryption of input contents (that is, video contents), generates a corresponding SVC bitstream, and transmits the generated SVC bitstream to the NAL data analysis unit 102b.

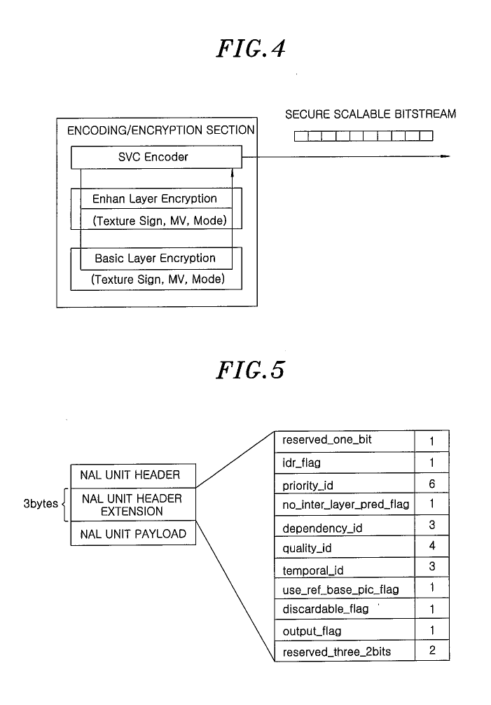

FIG. 4 is a diagram showing an encoding/encryption unit generating an SVC bitstream based on SVC encryption during contents encoding in accordance with an embodiment of the invention. It can be seen that selective encryption for a sign bit of an integer transform coefficient by layer of a base layer in an SVC encoding structure, a motion vector, a prediction mode and the like, i.e., encryption for at least one item is carried out to generate an encrypted SVC bitstream. The integer transform sign bit means a sign bit of a non-zero coefficient that is generated after integer transform, the motion vector means a residual value of the motion vector, and the prediction mode means information regarding directional modes for example, nine, four, or the like in intra prediction.

The NAL data analysis unit 102b analyzes NAL data of the SVC bitstream transmitted from the encoding/encryption unit 102a, extracts NAL data conforming to a second encryption condition, and transmits the SVC bitstream and extracted NAL data to the conditional NAL data encryption unit 102c.

The conditional NAL data encryption unit 102c encrypts extracted NAL data in accordance with the second encryption condition, and transmits the SVC bitstream with encrypted NAL data to the bitstream transmitting unit 102d.

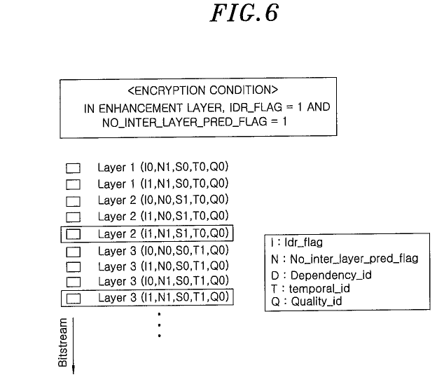

FIG. 5 is a diagram showing an SVC NAL head structure used in a conditional NAL data encryption unit, according to an embodiment of the invention. Information regarding spatial (dependency_id), quality (quality_id), temporal (temporal_id), use/disuse of interlayer prediction (no_inter_layer_pred_flag), use/disuse of IDR (idr_flag), and the like, and a payload portion corresponding to at least one item selected in accordance with the second encryption condition is encrypted. The conditional NAL data encryption unit 102c further carries out encryption for a region, which is not encrypted by the encoding/encryption unit 102a, by using the second encryption condition including the above-described information. With the combination of encryption based on the first encryption condition by the encoding/encryption unit 102a and encryption based on the second encryption condition by the conditional NAL data encryption unit 102c, maximum effects can be achieved in terms of computational complexity, data security, encryption load decentralization, and the like.

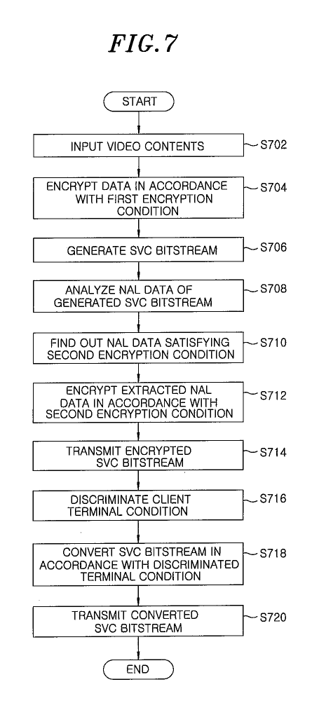

FIG. 6 is a diagram illustrating encryption of conditional NAL data in accordance with the embodiment of the invention. FIG. 6 shows the conditions on encryption of the payloads of all NAL data satisfying the condition ‘idr_flag=1’ for use/disuse of IDR in the enhancement layers, i.e., layer 2, layer 3 and the like other than the base layer, i.e., layer 1 and the condition ‘no_inter_layer_pred_flag=1’ for use/disuse of interlayer prediction. The base layer means a bitstream that can be independently decoded, and the enhancement layers mean bitstreams that are used to improve the bitstream in the base layer.

Next, the bitstream transmitting unit 102d transmits the SVC bitstream with encrypted NAL data to the streaming server 104.

If encryption based on the first encryption condition by the encoding/encryption unit 102a and encryption based on the second encryption condition by the conditional NAL data encryption unit 102c are carried out, a load due to encryption can be decentralized in accordance with the terminal condition of the client terminal apparatus 300, and computational complexity due to encryption can be selectively adjusted at two portions.

Next, a process in the contents providing system having the above-described configuration will be described, in which encryption is carried out for contents requested by the client terminal apparatus to generate an SVC bitstream, NAL data extracted from the generated SVC bitstream is encrypted, the SVC bitstream with encrypted NAL data is transmitted to the media conversion apparatus, for example, in a streaming manner or the like, the media conversion apparatus 200 carries out media conversion in accordance with the terminal condition of the client terminal apparatus and transmits the media-converted SVC bitstream to the client terminal apparatus 300, and the client terminal apparatus 300 decodes the transmitted media-converted SVC bitstream and reproduces corresponding contents.

FIG. 7 is a flowchart showing a process for providing SVC-encrypted contents to a client terminal apparatus in accordance with the embodiment of the invention.

Referring to FIG. 7, if the client terminal apparatus 300 requests to download arbitrary contents for example, video contents or the like, corresponding contents is inputted to the SVC encryption apparatus 102 in the contents service apparatus 100 in Step S702.

The encoding/encryption unit 102a of the SVC encryption apparatus 102 encrypts data in accordance with the first encryption condition during SVC encoding of the input contents, i.e., video contents in Step S704, generates a corresponding SVC bitstream, and transmits the generated SVC bitstream to the NAL data analysis unit 102b in Step S706.

Next, the NAL data analysis unit 102b analyzes NAL data of the SVC bitstream transmitted from the encoding/encryption unit 102a, and transmits the SVC bitstream and extracted NAL data to the conditional NAL data encryption unit 102c in Steps S708 and S710.

The conditional NAL data encryption unit 102c encrypts extracted NAL data in accordance with the second encryption condition, and transmits the SVC bitstream with encrypted NAL data to the bitstream transmitting unit 102d in Step S712.

Next, the bitstream transmitting unit 102d transmits the SVC bitstream with encrypted NAL data to the streaming server 104. The streaming server 104 transmits the SVC bitstream with encrypted NAL data, which is transmitted from the SVC encryption apparatus 102, to the media conversion apparatus 200, for example, in a streaming manner or the like in Step S714.

Next, the media conversion apparatus 200 discriminates the terminal condition for example, CPU performance, video codec performance and the like of the client terminal apparatus 300 in Step S716.

The media conversion apparatus 200 carries out media conversion for the SVC bitstream transmitted from the streaming server 104, in accordance with the discriminated terminal condition in step S718.

Next, the media con718version apparatus 200 transmits the media-converted SVC bitstream to the client terminal apparatus 300 in Step S720.

Thereafter, the client terminal apparatus 300 decodes the media-converted SVC bitstream transmitted from the media conversion apparatus 200, and reproduces corresponding contents.

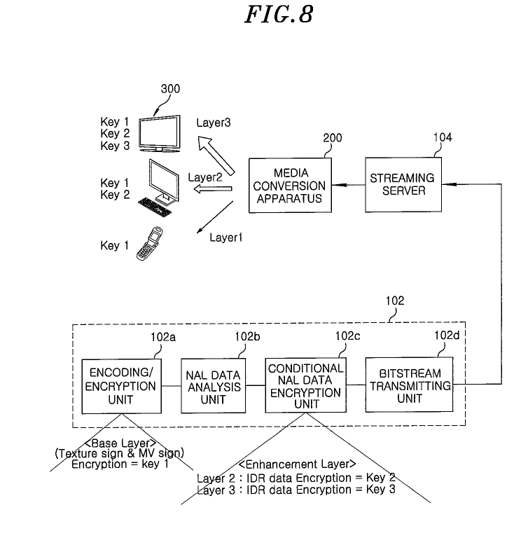

FIG. 8 is a diagram illustrating a process for converting video contents depending on a terminal condition and providing converted video contents according to the embodiment of the invention when encrypted video contents is transmitted. If requested video contents is inputted to the encoding/encryption unit 102a of the SVC encryption apparatus 102, ‘integer transform coefficient sign (texture sign)’ and ‘MV (motion vector)’ in the base layer are encrypted with an encryption key ‘Key 1’ to generate an SVC bitstream. The NAL data analysis unit 102b analyzes and extracts NAL data from the generated SVC bitstream. The conditional NAL data encryption unit 102c carries out encryption for extracted NAL data, i.e., ‘IDR data’ in the enhancement layer ‘layer 2’ and ‘All data’ in the enhancement ‘layer 3’ with encryption keys ‘Key 2’ and ‘Key 3’, respectively, and transmits the SVC bitstream encrypted on the multiple conditions to the streaming server 104 through the bitstream transmitting unit 102d.

The streaming server 104 transmits the SVC bitstream to the media conversion apparatus 200 including a transcoder, for example, in a streaming manner or the like. The media conversion apparatus 200 discriminates the terminal condition of the client terminal apparatus 300, and carries out media conversion in accordance with the terminal condition. Specifically, when the client terminal apparatus 300 is an uppermost digital TV, media conversion is carried out such that decoding can be carried out with all ‘Key 1’, ‘Key 2’, and ‘Key 3’, and corresponding contents is transmitted to the digital TV. In case of an intermediate PC, media conversion is carried out such that decoding can be carried out with ‘Key 1’ and ‘Key 2’, and corresponding contents is transmitted to the PC. In the case of a lowermost mobile communication terminal, media conversion is carried out such that decoding can be carried out only with ‘Key 1’, and corresponding contents is transmitted to the mobile communication terminal.

Therefore, requested contents is encrypted in accordance with the first encryption condition and then encrypted in accordance with the second encryption condition, and encrypted contents is transmitted. In this way, while the load due to encryption is decentralized in accordance with the terminal condition, corresponding contents is provided to the client terminal apparatus, and decoding is carried out in accordance with the terminal condition. As a result, contents can be effectively provided.

While the invention has been shown and described with respect to the embodiment, it will be understood by those skilled in the art that various changes and modifications may be made without departing from the scope of the invention as defined in the following claims.

What is claimed is:

1. An SVC encryption apparatus comprising:
an encoding/encryption unit for performing SVC (Scalable Video Coding) encoding on input data contents and carrying out encryption for data in accordance with a first encryption condition to generate a corresponding SVC bitstream;
a NAL (Network Adaptation Layer) data analysis unit for analyzing NAL data of the generated SVC bitstream to find out NAL data satisfying a second encryption condition;
a conditional NAL data encryption unit for encrypting the extracted NAL data in accordance with the second encryption condition; and
a bitstream transmitting unit for transmitting the SVC bitstream with encrypted NAL data.

2. The apparatus of claim 1, wherein the encoding/encryption unit selectively encrypts a base layer in an encoding structure in accordance with the first encryption condition during the SVC encryption.

3. The apparatus of claim 2, wherein the encoding/encryption unit selectively encrypts one or more of a sign bit of an integer transform coefficient by layer, a motion vector, and a prediction mode in accordance with the first encryption condition.

4. The apparatus of claim 1, wherein the conditional NAL data encryption unit encrypts an enhancement layer in a head structure of NAL data in accordance with the second encryption condition.

5. The apparatus of claim 4, wherein the conditional NAL data encryption unit analyzes information about spatial (dependency_id), quality (quality_id), temporal (temporal_id), use/disuse of interlayer prediction (no_inter_layer_pred_flag), and use/disuse of IDR (idr_flag), and encrypts a payload portion corresponding to one or more selected item in accordance with the second encryption condition.

6. An SVC encryption method comprising:
performing SVC (Scalable Video Coding) encoding on input contents and carrying out encryption for data in accordance with a first encryption condition to generate a corresponding SVC bitstream;
analyzing NAL (Network Adaptation Layer) data of the generated SVC bitstream to find out NAL data satisfying a second encryption condition;
encrypting extracted NAL data in accordance with the second encryption condition; and
transmitting the SVC bitstream with encrypted NAL data.

7. The method of claim 6, wherein said generating the SVC bitstream, a base layer is selectively encrypted in an encoding structure in accordance with the first encryption condition during the SVC encoding.

8. The method of claim 7, wherein said generating the SVC bitstream, selective encryption is carried out for one or more of a sign bit of an integer transform coefficient by layer, a motion vector, and a prediction mode in accordance with the first encryption condition.

9. The method of claim 6, wherein said encrypting in accordance with the second encryption condition, an enhancement layer is encrypted in a head structure of NAL data in accordance with the second encryption condition.

10. The method of claim 9, wherein said encrypting in accordance with the second encryption condition, information about spatial (dependency_id), quality (quality_id), temporal (temporal_id), use/disuse of interlayer prediction (no_inter_layer_pred_flag), and use/disuse of IDR (idr_flag) is analyzed, and a payload portion corresponding to one or more selected item is encrypted in accordance with the second encryption condition.

11. An contents providing system comprising:
a contents service apparatus for carrying out SVC (Scalable Video Coding) encryption of requested contents to generate an SVC bitstream, and encrypting NAL data extracted from the generated SVC bitstream to transmit the SVC bitstream with the encrypted NAL data;
a media conversion apparatus for carrying out media conversion for the transmitted SVC bitstream in accordance with a terminal condition; and
a client terminal apparatus for decoding the media-converted SVC bitstream to reproduce corresponding contents.

12. The system of claim 11, wherein the contents service apparatus includes:
an SVC encryption apparatus for carrying out the SVC encryption and generating the SVC bitstream to encrypt NAL data extracted from the generated SVC bitstream; and
a streaming server for transmitting the SVC bitstream with encrypted NAL data in a streaming manner.

13. The system of claim 12, wherein the SVC encryption apparatus includes:
an encoding/encryption unit for SVC (Scalable Video Coding) encoding the requested contents and carrying out encryption in accordance with a first encryption condition to generate a corresponding SVC bitstream;
a NAL data analysis unit for analyzing NAL data of the generated SVC bitstream to find out NAL data satisfying a second encryption condition;
a conditional NAL data for encryption unit encrypting extracted NAL data in accordance with the second encryption condition; and
a bitstream transmitting unit for transmitting the SVC bitstream with encrypted NAL data.

14. The system of claim 13, wherein the encoding/encryption unit selectively encrypts a base layer in an encoding structure in accordance with the first encryption condition during the SVC encryption.

15. The system of claim 13, wherein the conditional NAL data encryption unit encrypts an enhancement layer in a head structure of NAL data in accordance with the second encryption condition.

16. The system of claim 11, wherein the media conversion apparatus converts the SVC bitstream such that the SVC bitstream is decoded in the client terminal apparatus in accordance with the terminal condition.

17. A contents providing method comprising:
SVC (Scalable Video Coding) encrypting for requested contents to generate an SVC bitstream;
encrypting NAL data extracted from the generated SVC bitstream;
transmitting the SVC bitstream with encrypted NAL data;
carrying out media conversion for the transmitted SVC bitstream in accordance with a terminal condition to transmit the media-converted SVC bitstream to a client terminal apparatus.

18. The method of claim 17, wherein said generating the SVC bitstream further comprising:
selectively encrypting a base layer in an encoding structure in accordance with the first encryption condition during the SVC encoding of the requested contents.

19. The method of claim 17, wherein said encrypting extracted NAL data further comprising:
encrypting an enhancement layer in a head structure of NAL data in accordance with the second encryption condition.

20. The method of claim 17, wherein said carrying out the media conversion to transmit the media-converted SVC bitstream to the client terminal apparatus further comprising:
converting the SVC bitstream such that the SVC bitstream is decoded in the client terminal apparatus in accordance with the terminal condition.
